(19) United States
(12) Patent Application Publication
(10) Pub. No.: US 2009/0119328 A1
(43) Pub. Date: May 7, 2009

(54) Bookmarks for program note information

(75) Inventors: Ali Raza, Playa Del Ray, CA (US); Christopher Strader, Valencia, CA (US)

Correspondence Address: ROPES & GRAY LLP, PATENT DOCKETING 39/361, 1211 AVENUE OF THE AMERICAS, NEW YORK, NY, 10036-8704, US

(73) Assignee: United Video Properties, Inc., Los Angeles, CA (US)

(21) Appl. No.: 11/982,971

(22) Filed: Nov. 5, 2007

(51) Int. Cl. G06F 17/30

(52) U.S. Cl. 707/102; 707/E17.01

(57) ABSTRACT

Systems and methods for saving information related to selected media content are provided. The user may select a particular media item (e.g., a television program) and view information associated with the selected media. In response to a user request to save or bookmark the information associated with the media for future retrieval, the interactive media guidance application may save the viewed information (e.g., set a flag or setting to prevent the information from being deleted from a source). The user may later view listings of bookmarked information, select a listing, and display again the saved information. In some embodiments, the user may direct the interactive media guidance application to perform an interactive media guidance application operation (e.g., view, record, reminder or purchase) on a program related to the saved information or on a listing of bookmarked information (e.g., move, delete, copy, or set priority).

### BACKGROUND OF THE INVENTION

This invention is directed to an interactive media guidance application for saving information associated with media content, such as a television program, for future use.

Using known interactive media guidance applications, such as interactive television applications, users may access information related to television programs and other media available using user equipment such as, for example, a television, a mobile device, a computer, or any other such electronic device. For example, users may access program listings of media available to the user (e.g., as television programs). In some embodiments, users may direct the interactive media guidance application to schedule media for recording or downloading using one or more user equipment devices.

In some embodiments, an interactive media guidance application may provide a user with detailed information related to particular media content (e.g., detailed information for a television program selected by the user). The detailed information may be displayed using any suitable approach, including for example as a new page (e.g., a new web page) or as part of an existing interactive media guidance application display (e.g., in a window with listings). When the user directs the interactive media guidance application to change the display, the detailed information is removed from view, and available only when the user repeats the prior process of selecting the particular media content, and directing the interactive media guidance application to display the detailed information related to the selected particular media content. In addition, because information is typically provided for media available only in a limited future window (e.g., the interactive media guidance application receives program note information for the following 7 days of television programming), users may not be able to retrieve information associated with a program that was transmitted in the past or that will be transmitted in the far out future.

### SUMMARY OF THE INVENTION

In view of the foregoing, an interactive media guidance application that allows users to access information associated with media content outside of the limited future window may be provided. A user may view information related to selected media content (e.g., a selected program) using any suitable approach. For example, while the interactive media guidance application has access to information associated with a selected program (e.g., the transmission time of the program is within the limited future window), the user may direct the interactive media guidance application to display the information. If the user determines that the information is of particular interest, the user may direct the interactive media guidance application to save or bookmark the information (e.g., provide a SAVE or BOOKMARK instruction using a user input interface).

In response to receiving the bookmark or save instruction, the interactive media guidance application may save some or all of the information associated with the program. For example, the interactive media guidance application may save all information available for display to the user at the time the bookmark instruction was received. As another example, the interactive media guidance application may save the information available for display that does not expire (e.g., do not save future program listings) or that does not take up a large amount of memory (e.g., do not save video clips or photos). If the information is displayed on several pages, the interactive media guidance application may save all of the available pages, or only the page displayed when the bookmark or save instruction was received.

The interactive media guidance application may save the bookmarked information using any suitable approach. For example, the interactive media guidance application may direct a user equipment device to locally store the information. As another example, the interactive media guidance application may direct a remote server to store the information. As still another example, the interactive media guidance application may direct the source of the information (e.g., a data source or a media source) not to delete the information (e.g., using flags or changing settings associated with the information). The interactive media guidance application may associate bookmarked information with the particular user who requested the information be bookmarked using any suitable approach. In some embodiments, the stored information may be tagged with identification information for the user. As another example, the user's profile may include a field listing bookmarked information (e.g., having pointers to the locations in memory or storage of the saved information).

The user may access the saved information using any suitable approach. For example, the user may direct the interactive media guidance application to display listings for the bookmarked information. In response to receiving a user selection of a listing, the interactive media guidance application may display the saved information. If several pages of information are available, the interactive media guidance application may allow the user to navigate the several pages. In some embodiments, the interactive media guidance application may include options for the user to manipulate the listings of bookmarked information. For example, the interactive media guidance application may include options to add or delete listings, reorder listings, assign priorities to listings, organize listings in folders or groups (e.g., using tags), or perform any other suitable operation.

In some embodiments, the interactive media guidance application may provide options for the user to perform an interactive media guidance application operation on media content related to bookmarked information. For example, in response to receiving a user request to view saved information, the interactive media guidance application may identify future transmissions of programs related to the saved information (e.g., the program associated with the saved information, another episode in the same series, or a program having similar attributes) and provide options for performing interactive media guidance application operations with the identified transmissions. Such operations may include, for example, recording, setting a reminder, purchasing (e.g., downloading or purchasing a DVD), purchasing access (e.g., a VOD or PPV program), or any other suitable interactive media guidance application operation.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows an illustrative interactive media guidance application display screen in accordance with one embodiment of the invention;

FIG. 2 shows another illustrative interactive media guidance application display screen in accordance with one embodiment of the invention;

FIG. 3 is a diagram of an illustrative user equipment in accordance with one embodiment of the invention;

FIG. 4 is a diagram of an illustrative media system in accordance with one embodiment of the invention;

FIG. 5 is an illustrative interactive media guidance application screen for displaying additional information for a selected program in accordance with one embodiment of the invention;

FIG. 6 is an illustrative display screen of a user's bookmarks in accordance with one embodiment of the invention;

FIG. 7 is a flow chart of an illustrative process for saving information for a program in accordance with one embodiment of the invention; and

FIG. 8 is a flowchart of an illustrative process for accessing saved information associated with a program in accordance with one embodiment of the invention.

### DETAILED DESCRIPTION

The amount of media available to users in any given media delivery system can be substantial. Consequently, many users desire a form of media guidance through an interface that allows users to efficiently navigate media selections and easily identify media that they may desire. An application which provides such guidance is referred to herein as an interactive media guidance application or, sometimes, a media guidance application or a guidance application.

Interactive media guidance applications may take various forms depending on the media for which they provide guidance. One typical type of media guidance application is an interactive television program guide. Interactive television program guides (sometimes referred to as electronic program guides) are well-known guidance applications that, among other things, allow users to navigate among and locate many types of media content including conventional television programming (provided via traditional broadcast, cable, satellite, Internet, or other means), as well as pay-per-view programs, on-demand programs (as in video-on-demand (VOD) systems), Internet content (e.g., streaming media, downloadable media, Webcasts, etc.), and other types of media or video content. Guidance applications also allow users to navigate among and locate content related to the video content including, for example, video clips, articles, advertisements, chat sessions, games, etc.

With the advent of the Internet, mobile computing, and high-speed wireless networks, users are accessing media on personal computers (PCs) and other devices on which they traditionally did not, such as hand-held computers, personal digital assistants (PDAs), mobile telephones, or other mobile devices. On these devices users are able to navigate among and locate the same media available through a television. Consequently, media guidance is necessary on these devices, as well. The guidance provided may be for media content available only through a television, for media content available only through one or more of these devices, or for media content available both through a television and one or more of these devices. The media guidance applications may be provided as on-line applications (i.e., provided on a web-site), or as stand-alone applications or clients on hand-held computers, PDAs, mobile telephones, or other mobile devices. The various devices and platforms that may implement media guidance applications are described in more detail below.

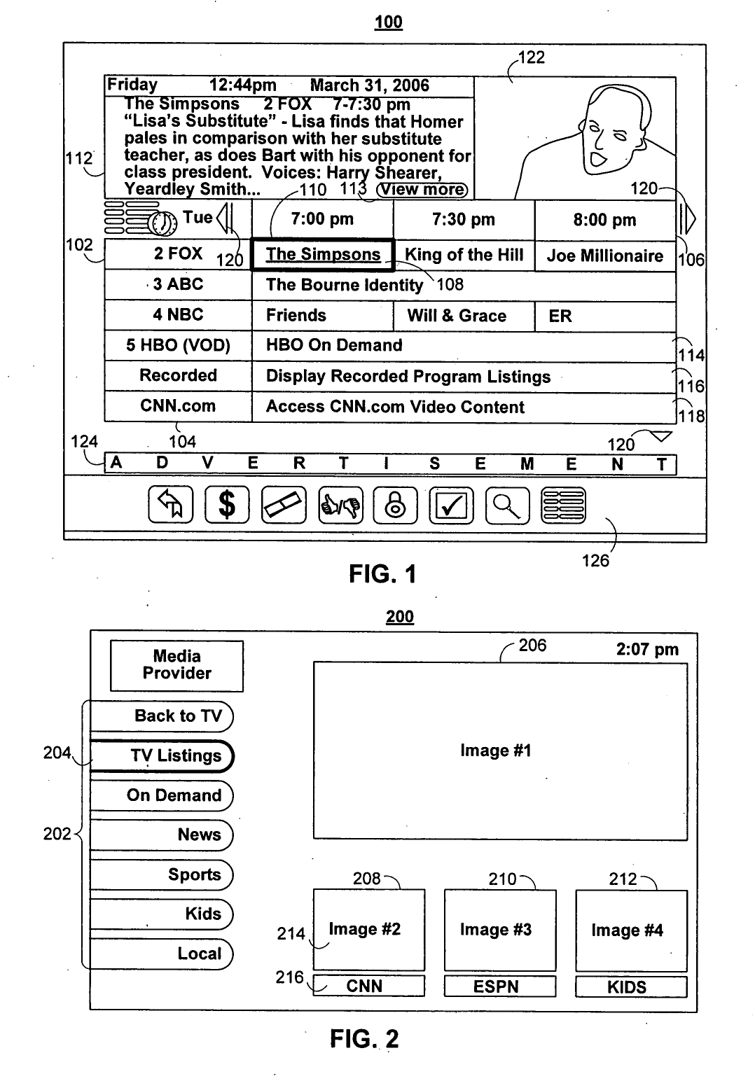

One of the functions of the media guidance application is to provide media listings and media information to users. FIGS. 1-2 show illustrative display screens that may be used to provide media guidance, and in particular media listings. The display screens shown in FIGS. 1-2 and 5-6 may be implemented on any suitable device or platform. While the displays of FIGS. 1-2 and 5-6 are illustrated as full screen displays, they may also be fully or partially overlaid over media content being displayed. A user may indicate a desire to access media information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media information organized in one of several ways, such as by time and channel in a grid, by time, by channel, by media type, by category (e.g., movies, sports, news, children, or other categories of programming), or other predefined, user-defined, or other organization criteria.

FIG. 1 shows illustrative grid program listings display 100 arranged by time and channel that also enables access to different types of media content in a single display. Display 100 may include grid 102 with: (1) a column of channel/media type identifiers 104, where each channel/media type identifier (which is a cell in the column) identifies a different channel or media type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, actors, genre, and other desired information. In some embodiments, region 112 may include an option (e.g., “View more” option 113) for viewing additional information not initially displayed in region 112 (e.g., due to lack of space).

In addition to providing access to linear programming provided according to a schedule, the media guidance application also provides access to non-linear programming which is not provided according to a schedule. Non-linear programming may include content from different media sources including on-demand media content (e.g., VOD), Internet content (e.g., streaming media, downloadable media, etc.), locally stored media content (e.g., video content stored on a digital video recorder (DVR), digital video disc (DVD), video cassette, compact disc (CD), etc.), or other time-insensitive media content. On-demand content may include both movies and original media content provided by a particular media provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming media or downloadable media through an Internet web site or other Internet access (e.g. FTP).

Grid 102 may provide listings for non-linear programming including on-demand listing 114, recorded media listing 116, and Internet content listing 118. A display combining listings for content from different types of media sources is sometimes referred to as a “mixed-media” display. The various permutations of the types of listings that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In other embodiments, listings for these media types may be included directly in grid 102. Additional listings may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the present invention.

Advertisement 124 may provide an advertisement for media content that, depending on a viewer's access rights (e.g., for subscription programming), is currently available for viewing, will be available for viewing in the future, or may never become available for viewing, and may correspond to or be unrelated to one or more of the media listings in grid 102. Advertisement 124 may also be for products or services related or unrelated to the media content displayed in grid 102. Advertisement 124 may be selectable and provide further information about media content, provide information about a product or a service, enable purchasing of media content, a product, or a service, provide media content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over media content or a guidance application display or embedded within a display. Advertisements may also include text, images, rotating images, video clips, or other types of media content. Advertisements may be stored in the user equipment with the guidance application, in a database connected to the user equipment, in a remote location (including streaming media servers), or on other storage means or a combination of these locations. Providing advertisements in a media guidance application is discussed in greater detail in, for example, Knudson et al., U.S. patent application Ser. No. 10/347,673, filed Jan. 17, 2003, Ward, III et al. U.S. Pat. No. 6,756,997, issued Jun. 29, 2004, and Schein et al. U.S. Pat. No. 6,388,714, issued May 14, 2002, which are hereby incorporated by reference herein in their entireties. It will be appreciated that advertisements may be included in other media guidance application display screens of the present invention.

Options region 126 may allow the user to access different types of media content, media guidance application displays, and/or media guidance application features. Options region 126 may be part of display 100 (and other display screens of the present invention), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, access to various types of listing displays, subscribe to a premium service, edit a user's profile, access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of media content listings displayed (e.g., only HDTV programming, user-specified broadcast channels based on favorite channel selections, re-ordering the display of channels, recommended media content, etc.), desired recording features (e.g., recording or series recordings for particular users, recording quality, etc.), parental control settings, and other desired customizations.

The media guidance application may allow a user to provide user profile information or may automatically compile user profile information. The media guidance application may, for example, monitor the media the user accesses and/or other interactions the user may have with the guidance application. Additionally, the media guidance application may obtain all or part of other user profiles that are related to a particular user (e.g., from other web sites on the Internet the user accesses, such as www.tvguide.com, from other media guidance applications the user accesses, from other interactive applications the user accesses, from a handheld device of the user, etc.), and/or obtain information about the user from other sources that the media guidance application may access. As a result, a user can be provided with a unified guidance application experience across the user's different devices. This type of user experience is described in greater detail below in connection with FIG. 4. Additional personalized media guidance application features are described in greater detail in Ellis et al., U.S. patent application Ser. No. 11/179,410, filed Jul. 11, 2005, Boyer et al., U.S. patent application Ser. No. 09/437,304, filed Nov. 9, 1999, and Ellis et al., U.S. patent application Ser. No. 10/105,128, filed Feb. 21, 2002, which are hereby incorporated by reference herein in their entireties.

Another display arrangement for providing media guidance is shown in FIG. 2. Video mosaic display 200 includes selectable options 202 for media content information organized based on media type, genre, and/or other organization criteria. In display 200, television listings option 204 is selected, thus providing listings 206, 208, 210, and 212 as broadcast program listings. Unlike the listings from FIG. 1, the listings in display 200 are not limited to simple text (e.g., the program title) and icons to describe media. Rather, in display 200 the listings may provide graphical images including cover art, still images from the media content, video clip previews, live video from the media content, or other types of media that indicate to a user the media content being described by the listing. Each of the graphical listings may also be accompanied by text to provide further information about the media content associated with the listing. For example, listing 208 may include more than one portion, including media portion 214 and text portion 216. Media portion 214 and/or text portion 216 may be selectable to view video in full-screen or to view program listings related to the video displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the media provider or based on user preferences. Various systems and methods for graphically accentuating media listings are discussed in, for example, Yates, U.S. patent application Ser. No. 11/324,202, filed Dec. 29, 2005, which is hereby incorporated by reference herein in its entirety.

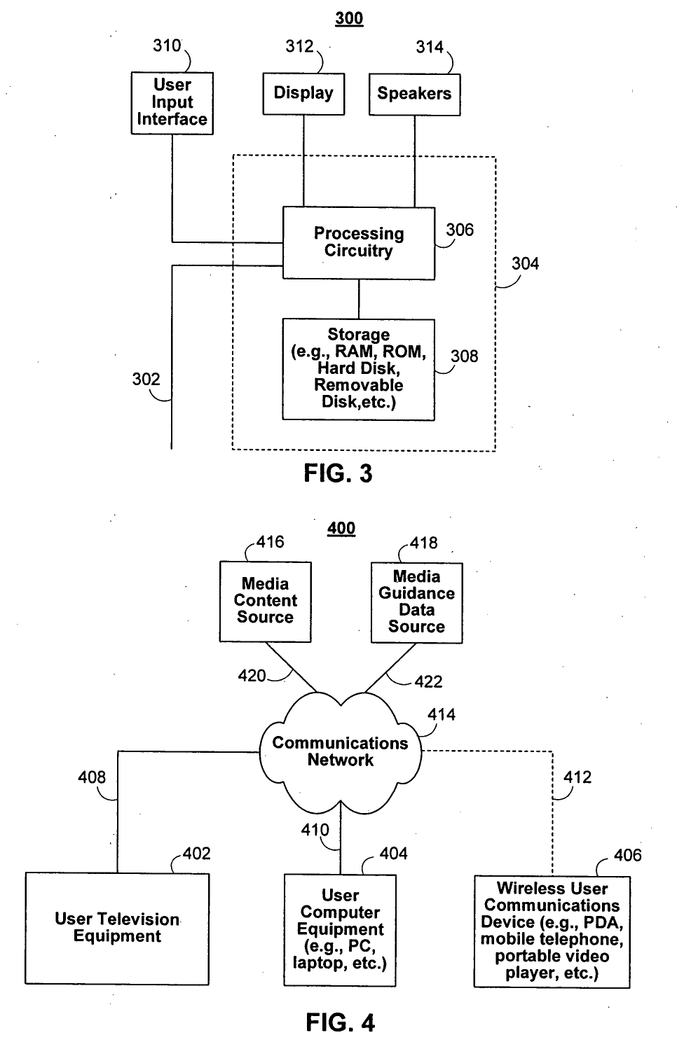

Users may access media content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive media content and data via input/output (hereinafter “I/O”) path 302. I/O path 302 may provide media content (e.g., broadcast programming, on-demand programming, Internet content, and other video or audio) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry 306 such as processing circuitry based on one or more microprocessors, microcontrollers, digital signal processors, programmable logic devices, etc. In some embodiments, control circuitry 304 executes instructions for a media guidance application stored in memory (i.e., storage 308). In client-server based embodiments, control circuitry 304 may include communications circuitry suitable for communicating with a guidance application server or other networks or servers. Communications circuitry may include a cable modem, an integrated services digital network (ISDN) modem, a digital subscriber line (DSL) modem, a telephone modem, or a wireless modem for communications with other equipment. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 308 that is part of control circuitry 304. Storage 308 may include one or more of the above types of storage devices. For example, user equipment device 300 may include a hard drive for a DVR (sometimes called a personal video recorder, or PVR) and a DVD recorder as a secondary storage device. Storage 308 may be used to store various types of media described herein and guidance application data, including program information, guidance application settings, user preferences or profile information, or other data used in operating the guidance application. Nonvolatile memory may also be used (e.g., to launch a boot-up routine and other instructions).

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting media into the preferred output format of the user equipment 300. Circuitry 304 may also include digital-to-analog converter circuitry and analog-to-digital converter circuitry for converting between digital and analog signals. The tuning and encoding circuitry may be used by the user equipment to receive and to display, to play, or to record media content. The tuning and encoding circuitry may also be used to receive guidance data. The circuitry described herein, including for example, the tuning, video generating, encoding, decoding, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may control the control circuitry 304 using user input interface 310. User input interface 310 may be any suitable user interface, such as a remote control, mouse, trackball, keypad, keyboard, touch screen, touch pad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. Speakers 314 may be provided as integrated with other elements of user equipment device 300 or may be stand-alone units. The audio component of videos and other media content displayed on display 312 may be played through speakers 314. In some embodiments, the audio may be distributed to a receiver (not shown), which processes and outputs the audio via speakers 314.

User equipment device 300 of FIG. 3 can be implemented in system 400 of FIG. 4 as user television equipment 402, user computer equipment 404, wireless user communications device 406, or any other type of user equipment suitable for accessing media, such as a non-portable gaming machine. For simplicity, these devices may be referred to herein collectively as user equipment or user equipment devices. User equipment devices, on which a media guidance application is implemented, may function as a standalone device or may be part of a network of devices. Various network configurations of devices may be implemented and are discussed in more detail below.

User television equipment 402 may include a set-top box, an integrated receiver decoder (IRD) for handling satellite television, a television set, a digital storage device, a DVD recorder, a video-cassette recorder (VCR), a local media server, or other user television equipment. One or more of these devices may be integrated to be a single device, if desired. User computer equipment 404 may include a PC, a laptop, a tablet, a WebTV box, a personal computer television (PC/TV), a PC media server, a PC media center, or other user computer equipment. WEBTV is a trademark owned by Microsoft Corp. Wireless user communications device 406 may include PDAs, a mobile telephone, a portable video player, a portable music player, a portable gaming machine, or other wireless devices.

It should be noted that with the advent of television tuner cards for PC's, WebTV, and the integration of video into other user equipment devices, the lines have become blurred when trying to classify a device as one of the above devices. In fact, each of user television equipment 402, user computer equipment 404, and wireless user communications device 406 may utilize at least some of the system features described above in connection with FIG. 3 and, as a result, include flexibility with respect to the type of media content available on the device. For example, user television equipment 402 may be Internet-enabled allowing for access to Internet content, while user computer equipment 404 may include a tuner allowing for access to television programming. The media guidance application may also have the same layout on the various different types of user equipment or may be tailored to the display capabilities of the user equipment. For example, on user computer equipment, the guidance application may be provided as a web site accessed by a web browser. In another example, the guidance application may be scaled down for wireless user communications devices.

In system 400, there is typically more than one of each type of user equipment device but only one of each is shown in FIG. 4 to avoid overcomplicating the drawing. In addition, each user may utilize more than one type of user equipment device (e.g., a user may have a television set and a computer) and also more than one of each type of user equipment device (e.g., a user may have a PDA and a mobile telephone and/or multiple television sets).

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.tvguide.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile device (e.g., Blackberry) network, cable network, public switched telephone network, or other types of communications network or combinations of communications networks. BLACKBERRY is a service mark owned by Research In Motion Limited Corp. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes media content source 416 and media guidance data source 418 coupled to communications network 414 via communication paths 420 and 422, respectively. Paths 420 and 422 may include any of the communication paths described above in connection with paths 408, 410, and 412. Communications with the media content source 416 and media guidance data source 418 may be exchanged over one or more communications paths, but are shown as a single path in FIG. 4 to avoid overcomplicating the drawing. In addition, there may be more than one of each of media content source 416 and media guidance data source 418, but only one of each is shown in FIG. 4 to avoid overcomplicating the drawing. (The different types of each of these sources are discussed below.) If desired, media content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Media content source 416 may include one or more types of media distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other media content providers. NBC is a trademark owned by the National Broadcasting Company, Inc., ABC is a trademark owned by the ABC, INC., and HBO is a trademark owned by the Home Box Office, Inc. Media content source 416 may be the originator of media content (e.g., a television broadcaster, a Webcast provider, etc.) or may not be the originator of media content (e.g., an on-demand media content provider, an Internet provider of video content of broadcast programs for downloading, etc.). Media content source 416 may include cable sources, satellite providers, on-demand providers, Internet providers, or other providers of media content. Media content source 416 may also include a remote media server used to store different types of media content (including video content selected by a user), in a location remote from any of the user equipment devices. Systems and methods for remote storage of media content, and providing remotely stored media content to user equipment are discussed in greater detail in connection with Ellis et al., U.S. patent application Ser. No. 09/332,244, filed Jun. 11, 1999, which is hereby incorporated by reference herein in its entirety.

Media guidance data source 418 may provide media guidance data, such as media listings, media-related information (e.g., broadcast times, broadcast channels, media titles, media descriptions, ratings information (e.g., parental control ratings, critic's ratings, etc.), genre or category information, actor information, logo data for broadcasters' or providers' logos, etc.), media format (e.g., standard definition, high definition, etc.), advertisement information (e.g., text, images, media clips, etc.), on-demand information, and any other type of guidance data that is helpful for a user to navigate among and locate desired media selections.

Media guidance application data may be provided to the user equipment devices using any suitable approach. In some embodiments, the guidance application may be a stand-alone interactive television program guide that receives program guide data via a data feed (e.g., a continuous feed, trickle feed, or data in the vertical blanking interval of a channel). Program schedule data and other guidance data may be provided to the user equipment on a television channel sideband, in the vertical blanking interval of a television channel, using an in-band digital signal, using an out-of-band digital signal, or by any other suitable data transmission technique. Program schedule data and other guidance data may be provided to user equipment on multiple analog or digital television channels. Program schedule data and other guidance data may be provided to the user equipment with any suitable frequency (e.g., continuously, daily, a user-specified period of time, a system-specified period of time, in response to a request from user equipment, etc.). In some approaches, guidance data from media guidance data source 418 may be provided to users' equipment using a client-server approach. For example, a guidance application client residing on the user's equipment may initiate sessions with source 418 to obtain guidance data when needed. Media guidance data source 418 may provide user equipment devices 402, 404, and 406 the media guidance application itself or software updates for the media guidance application.

Media guidance applications may be, for example, stand-alone applications implemented on user equipment devices. In other embodiments, media guidance applications may be client-server applications where only the client resides on the user equipment device. For example, media guidance applications may be implemented partially as a client application on control circuitry 304 of user equipment device 300 and partially on a remote server as a server application (e.g., media guidance data source 418). The guidance application displays may be generated by the media guidance data source 418 and transmitted to the user equipment devices. The media guidance data source 418 may also transmit data for storage on the user equipment, which then generates the guidance application displays based on instructions processed by control circuitry.

Media guidance system 400 is intended to illustrate a number of approaches, or network configurations, by which user equipment devices and sources of media content and guidance data may communicate with each other for the purpose of accessing media and providing media guidance. The present invention may be applied in any one or a subset of these approaches, or in a system employing other approaches for delivering media and providing media guidance. The following three approaches provide specific illustrations of the generalized example of FIG. 4.

In one approach, user equipment devices may communicate with each other within a home network. User equipment devices can communicate with each other directly via short-range point-to-point communication schemes describe above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit media content. For example, a user may transmit media content from user computer equipment to a portable video player or portable music player.

In a second approach, users may have multiple types of user equipment by which they access media content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. patent application Ser. No. 10/927,814, filed Aug. 26, 2004, which is hereby incorporated by reference herein in its entirety.

In a third approach, users of user equipment devices inside and outside a home can use their media guidance application to communicate directly with media content source 416 to access media content. Specifically, within a home, users of user television equipment 404 and user computer equipment 406 may access the media guidance application to navigate among and locate desirable media content. Users may also access the media guidance application outside of the home using wireless user communications devices 406 to navigate among and locate desirable media content.

It will be appreciated that while the discussion of media content has focused on video content, the principles of media guidance can be applied to other types of media content, such as music, images, etc.

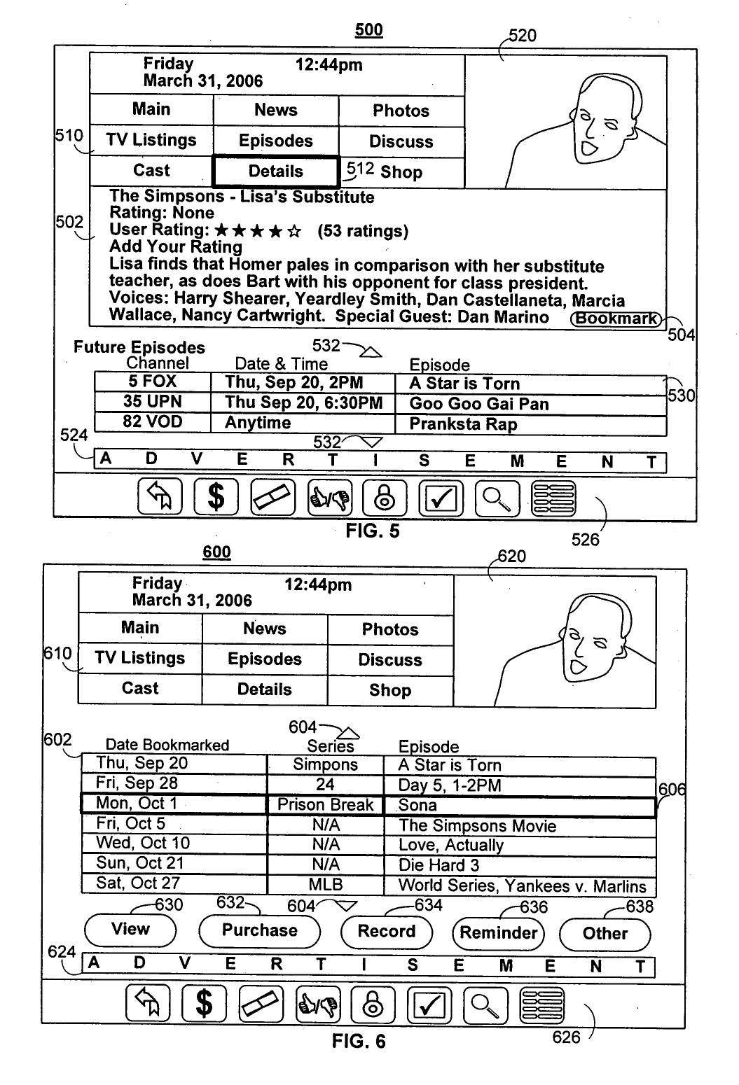

In some embodiments, a user may select a listing (e.g., from grid 102 using highlight region 110, FIG. 1) to view additional information for the selected program. For example, the user may highlight a program listing and press an INFO key or key sequence using a user input interface (e.g., user input interface 310, FIG. 3), by selecting an on-screen INFO option (e.g., from options region 126, FIG. 1), or by selecting an on-screen VIEW MORE option (e.g., View More option 113, FIG. 1). In response to receiving the user request to display additional information, the interactive media guidance application may display an additional information screen. FIG. 5 is an illustrative interactive media guidance application screen for displaying additional information for a selected program in accordance with one embodiment of the invention. Display screen 500 may include information region 502, information options 510, and video region 520.

Information region 502 may include information related to the program selected prior to accessing display screen 500. For example, information region 502 may include detailed information such as a program title, rating, user rating, and summary. The user may view different types of information related to the selected program by selecting different information options 510 (e.g., using highlight region 512). For example, the user may view a brief overview of information related to the selected program in response to selecting the MAIN option. The user may view news related to the selected program or series by selecting the NEWS option, and view photos (e.g., screenshots) for the selected program by selecting the PHOTOS option.

In some embodiments, the user may view TV listings for the selected program or for the series of the selected program in information region 502 in response to selecting the TV LISTINGS option. If the selected program is a series or an episode of a series, the user may view a list of all episodes by selecting the EPISODES option. If the selected program is not a series or an episode of a series, the EPISODES option may be unselectable (e.g., grayed out) or not displayed. The user may view the cast associated with the selected program by selecting the CAST option, and view detailed information about the selected program in by selecting the DETAILS option (e.g., as shown in display screen 500).

In some embodiments, the user may access a chat application or discussion board or forum related to the selected program by selecting the DISCUSS option. In response to selecting the DISCUSS option, the interactive media guidance application may display a new page with a discussion board or forum, or may initialize a chat or other non-interactive media guidance application for allowing the user to discuss the selected program with other users.

In some embodiments, the user may access a shopping application or shopping display screen for ordering or purchasing items related to the selected program by selecting the SHOP option. In some embodiments, the interactive media guidance application may provide the user with an opportunity to purchase products related to the selected program (e.g., apparel, books, coffee mugs, or images). In some embodiments, the interactive media guidance application may provide the user with an opportunity to purchase the selected program or access to the selected program (e.g., order the program on PPV or VOD, download the selected program, or order a DVD of the selected program).

The interactive media guidance application may display any suitable media in video region 520. For example, the interactive media guidance application may display a video clip, an image, a transmitted program (e.g., a broadcast program), or any other suitable media. The displayed media may or may not be related to the selected program.

Display screen 500 may include any other information of interest to the user. For example, display screen 500 may include program listings 530 of media content which may or may not be related to the selected program. Listings 530 may include any suitable types of listings, including for example broadcast or satellite media, media available for download or as a stream (e.g., over the Internet), or media available on demand (e.g., VOD) or as PPV. The interactive media guidance application may display any suitable number of media listings in listings 530, the number of which may vary based on the amount of information displayed in information region 502. If more listings are available than are displayed, screen 500 may include selectable arrows 532 configured to allow scrolling of listings 530. The media displayed in listings 530 may include any suitable media, including for example media related to the selected program (e.g., other episodes of a selected series, programs having attributes in common with the selected program, or programs similarly ranked), media unrelated to the selected program (e.g., programs soon to be or currently transmitted, other programs of interest to the user, or programs selected by advertisers), or both.

In some embodiments, screen 500 may include one or more advertisements (e.g., advertisement 524), and one or more interactive media guidance application options (e.g., located in options region 526). The user may navigate to different pages of the interactive media guidance application using the options of option region 526, or by providing appropriate inputs using the user input interface.

In some embodiments, a user may determine that he has a particular interest in the selected program, and would like to save or bookmark the information associated with the program. To allow the user to do so, the interactive media guidance application may include a selectable BOOKMARK or SAVE option. For example, screen 500 may include selectable BOOKMARK option 504. As another example, the user may provide a BOOKMARK instruction by pressing a key or key sequence using a user input mechanism. In response to receiving the user's BOOKMARK instruction, the interactive media guidance application may save the information associated with the selected program in memory. For example, the interactive media guidance application may save the information displayed in information region 502 when the BOOKMARK instruction was received. As another example, the interactive media guidance application may save all of the information available from screen 500 (e.g., available in response to selecting any of information options 510). As still another example, the interactive media guidance application may save only some of the information available from screen 500 (e.g., not save media clips or photos because of the space needed in memory, or not save program listings because they will become outdated). In some embodiments, the program information alone is saved, whereas the underlying program is not (e.g., the program is not recorded or downloaded, for example to save space in memory or storage).

The interactive media guidance application may save the information related to the selected program using any suitable approach. In some embodiments, the interactive media guidance application may store the information locally in the device to which the BOOKMARK instruction was provided. For example, if the user instructs a set-top box to bookmark information related to a program, the interactive media guidance application may store the information in the set-top box memory or storage (e.g., RAM or hard drive). The stored information may be accessible only through the local device, or through any other device connected to the local device. As another example, the interactive media guidance application may store the information in a remote database (e.g., a web server accessible over the Internet) or device accessible from at least one user equipment device. For example, the information may be stored in a media content source (e.g., media content source 416, FIG. 4) or a media guidance data source (e.g., media guidance data source 418, FIG. 4). In some embodiments, instead of or in addition to storing the information in a location different than its current location (e.g., the location from which the information was received by the user's device), the interactive media guidance application may flag, tag, or change a setting associated with the information at the one or more sources of the information to prevent the information from being deleted.

The saved information may be associated with the user using any suitable approach. In some embodiments, the information may be stored in an account associated with the user. In some embodiments, a flag, tag, or setting may be set in memory to identify the user who requested the information be saved. If several users bookmarked the same information, a flag, tag or setting may be set for each of the users. In such embodiments, the bookmarked information may not be deleted until each user who bookmarked the information directs or allows the interactive media guidance application to delete the saved information.

The interactive media guidance application may keep track of information bookmarked by the user using any suitable approach. In some embodiments, the interactive media guidance application may include bookmark identifiers in the user's profile, one or more user equipment devices, or in a remote server accessible to the user (e.g., a web server). Each bookmark identifier may include any suitable information for identifying each instance of bookmarked information and for retrieving bookmarked information. For example, each bookmark identifier may include cursory information for identifying each bookmarked information (e.g., the information in each listing 602, FIG. 6). As another example, each bookmark identifier may include information for locating the bookmarked information in memory (e.g., a pointer for each item of bookmarked information). In some embodiments, the interactive media guidance application may, based on the records of bookmarked information, prevent the user from saving information for the same program twice (e.g., prevent two identical bookmarks).

To view bookmarked information, the user may select an on-screen option (e.g., from options region 126, FIG. 1) or enter a BOOKMARKS key or key sequence using a user input mechanism. In response to receiving the user request to view bookmarked information, the interactive media guidance application may display the user's bookmarks. The interactive media guidance application may identify which bookmarks to display using any suitable approach (e.g., an approach described above). FIG. 6 is an illustrative display screen of a user's bookmarks in accordance with one embodiment of the invention. Display screen 600 may include bookmarks listing 602, bookmarks options 610 and video region 620. Video region 620 may include some or all of the features discussed in connection with video region 520 (FIG. 5).

Bookmarks listing 602 may include listings of the programs for which the user's bookmarked information. Listings 602 may include any suitable information, including for example the date (and time) bookmarked, the name of the series (if applicable), the name of the episode (or program), or any other suitable information. Any suitable number of listings 602 may be displayed on display 600. If the user has bookmarked more programs than can be simultaneously displayed, the interactive media guidance application may display selectable arrows 604 for navigating listings. In some embodiments, the interactive media guidance application may display additional arrows for displaying additional information in a listing (e.g., for expanding a single row in listings 602).

The user may highlight a program listing by navigating highlight region 606 over the appropriate listing 602. To view the bookmarked information, the user may select an option from bookmarks options 610. In some embodiments, bookmarks options 610 may include some or all of the same options as information options 510 (FIG. 5). In response to selecting a bookmark option 610, the interactive media guidance application may display the stored information associated with the selected bookmark option. For example, the interactive media guidance application may display a screen similar to screen 500 of FIG. 5 (e.g., replace listings 602 in an information region having the requested information). In some embodiments, the interactive media guidance application may automatically identify future transmissions of programs related to the selected program (e.g., for display in program listings 530, FIG. 5). The screen in which the information is displayed may include options specific to bookmarks, including for example options 630, 632, 634, 636 and 638. By having access to the information related to a selected program, a user may refresh his memory regarding programs previously identified as being of interest, and identify particular programs with which to perform interactive media guidance application operations.

In some embodiments, the user may direct the interactive media guidance application to perform a particular interactive media guidance application function based on a program associated with bookmarked information. Display screen 600 may include several options for performing interactive media guidance application functions on programs for which information was bookmarked. For example, after identifying a program using highlight region 606, the user may select VIEW option 630 to view listings of future transmissions of the program or tune to and display a currently transmitted transmission of the program (e.g., in full screen or in video region 620). In some embodiments, if the interactive media guidance application cannot find the exact program selected by the user, the interactive media guidance application may provide recommendations for alternatives (e.g., other episodes in the series, or programs with similar attributes).

In some embodiments, the user may select PURCHASE option 632. In response to receiving a user selection of PURCHASE option 632, the interactive media guidance application may identify PPV, VOD, downloads and streams of the selected program available for purchase by the user. For example, the interactive media guidance application may display listings of available sources from which the program may be purchased. As another example, the interactive media guidance application may automatically display an ordering page (e.g., a PPV or VOD ordering page). As still another example, the interactive media guidance application may open a non-interactive media guidance application for purchasing media (e.g., open iTunes or Napster). In some embodiments, the interactive media guidance application may identify sources for purchasing hard copies of the selected program (e.g., Amazon.com, for purchasing a DVD). If the interactive media guidance application cannot find the exact program selected by the user, the interactive media guidance application may provide recommendations for alternatives (e.g., other episodes in the series, or programs with similar attributes).

In some embodiments, the user may select RECORD option 634. In response to receiving a user selection of RECORD option 634, the interactive media guidance application may identify future transmissions of the selected program. In some embodiments, the interactive media guidance application may automatically schedule one or more of the future transmissions for recording (e.g., based on the user's recording device capabilities and availability). In some embodiments, the interactive media guidance application may present listings of future transmissions for the user to select for recording. In response to a user selection of a future transmission, the interactive media guidance application may schedule the selected transmission for recording. If the interactive media guidance application cannot find the exact program selected by the user, the interactive media guidance application may provide recommendations for alternatives (e.g., other episodes in the series, or programs with similar attributes).

In some embodiments, the user may select REMINDER option 636. In response to receiving a user selection of REMINDER option 636, the interactive media guidance application may identify future transmissions of the selected program. In some embodiments, the interactive media guidance application may automatically set a reminder for one or more of the identified future transmissions (e.g., based on the user's viewing history and expected availability for viewing the future transmission). In some embodiments, the interactive media guidance application may present listings of future transmissions for the user to select and set a reminder. In response to a user selection of a future transmission, the interactive media guidance application may set a reminder for the selected transmission. If the interactive media guidance application cannot find the exact program selected by the user, the interactive media guidance application may provide recommendations for alternatives (e.g., other episodes in the series, or programs with similar attributes).

In some embodiments, the user may select OTHER option 638. In response to receiving a user selection of OTHER option 638, the interactive media guidance application may display several options for organizing or modifying the selected bookmark. For example, the interactive media guidance application may display an option for re-ordering the selected bookmark in listings 602. As another example, the interactive media guidance application may display options for combining bookmarks into groups or themes (e.g., using tags, or creating folders displayed in listings 602, the folders containing one or more bookmarks). As still another example, the interactive media guidance application may display an option to assign a priority to bookmarks (e.g., which may be used when determining which recordings or reminders to set). As yet still another example, the interactive media guidance application may include an option to remove a bookmark from listings 602, or an option to add a new bookmark to listings 602. In some embodiments, the options available in response to selecting OTHER option 638 may be displayed instead of or in addition to OTHER option 638, or in any other portion of screen 600 (e.g., in option region 626).

Display screen 600 may include one or more advertisements (e.g., advertisement 624). The interactive media guidance application may display any suitable advertisements, including advertisements targeted to the particular user. For example, the interactive media guidance application may identify, based on the bookmarked information, the user's interests and display advertisements that relate to the identified interests. Because the information used to identify the user's interests is reliable (e.g., the user actively selected to bookmark the particular information), displayed advertisements may be particularly accurately targeted. For example, if the user bookmarked information for a Simpsons episode, advertisement 624 may be directed to Simpsons action figures or toys, or books related to the Simpsons.

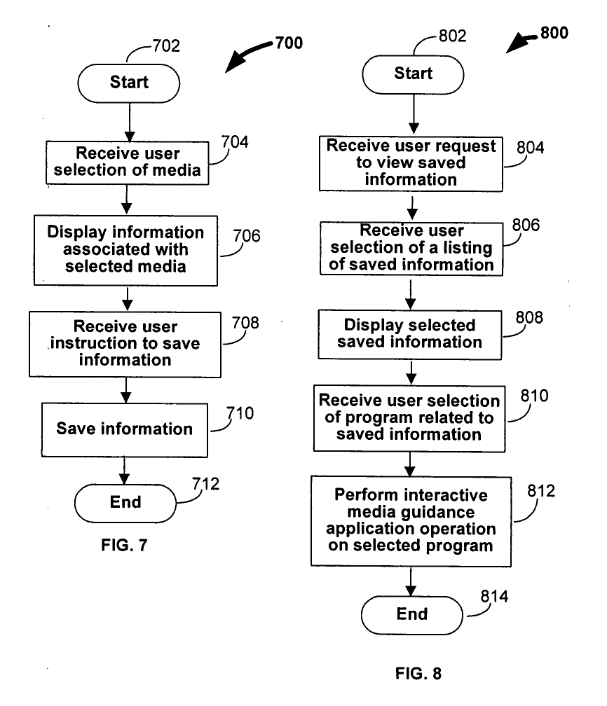

The following flow charts serve to illustrate processes involved in some embodiments of this invention. FIG. 7 is a flow chart of an illustrative process for saving information for a program in accordance with one embodiment of the invention. Process 700 begins at step 702. At step 704, the interactive media guidance application receives a user selection of media. For example, an interactive media guidance application directing processing circuitry (e.g., processing circuitry 306, FIG. 3) to perform operations may receive a selection of a program listing (e.g., from program grid 102, FIG. 1) from a user input interface (e.g., user input interface 310, FIG. 3).

At step 706, the interactive media guidance application displays information associated with the media selected at step 704. For example, in response to receiving a user request to view additional information related to a highlighted program (e.g., in response to a user selection of VIEW MORE option 113, FIG. 1), the interactive media guidance application may display information for the media (e.g., display screen 500, FIG. 5). The displayed information may include any suitable information related to the selected media, including for example summaries, news, photos, TV listings, episode lists, cast information, a discussion board or chat functionality, a shop, or any other information related to the selected media. At step 708, the interactive media guidance application receives a user instruction to save the information associated with the selected media. For example, the interactive media guidance application may receive a user selection of a BOOKMARK option, or a selection of a BOOKMARK key or key sequence selected while the information is displayed.

At step 710, the media application saves the information associated with the selected media. The interactive media guidance application may save the information using any suitable approach. For example, the interactive media guidance application may direct a user, equipment device or a remote device (e.g., a web server or data source) to store the bookmarked information. As another example, the interactive media guidance application may direct the one or more sources of the information to retain the information (e.g., not delete the information), for example using flags, tags, or by changing settings associated with the information. In some embodiments, the interactive media guidance application may save only the information that was displayed when the BOOKMARK instruction was received (e.g., the information associated with only one of information options 510, FIG. 5). In some embodiments, the interactive media guidance application may save all of the information available for display in response to receiving the BOOKMARK instruction. In some embodiments, the interactive media guidance application may save only some of the available information related to the selected media (e.g., not save TV listings, which expire, or not save video clips, photos or audio because of the amount of memory required). In some embodiments, the amount of information saved may change with time (e.g., initially save TV listings information, but delete information once no longer relevant). Process 700 then ends at step 712.

FIG. 8 is a flowchart of an illustrative process for accessing saved information associated with a program in accordance with one embodiment of the invention. Process 800 begins at step 802. At step 804, the interactive media guidance application receives a user request to view saved information. For example, the interactive media guidance application may receive a user selection of an on-screen BOOKMARKS option, or a BOOKMARKS key or key sequence from a user input interface (e.g., user input interface 310, FIG. 3). In response to receiving the user request, the interactive media guidance application may identify the saved information (e.g., using tags or identifiers stored in the user's profile) and display listings of the saved or bookmarked information (e.g., screen 600, FIG. 6).

At step 806, the interactive media guidance application receives a user selection of a listing of saved information. For example, the interactive media guidance application may receive a user selection of a bookmark listing (e.g., bookmark listing 602, FIG. 6). At step 808, the interactive media guidance application displays information related to the selected bookmark listing. For example, the interactive media guidance application may display a screen having options for accessing different types of information saved for the user (e.g., screen 500, FIG. 5). In some embodiments, the displayed information may include one or more program listings for the program associated with the displayed information or for programs related to the program associated with the displayed information.

At step 810, the interactive media guidance application receives a user selection of a program related to the selected saved information. For example, the interactive media guidance application may receive a user selection of a program listing (e.g., program listing 530, FIG. 5). At step 812, the interactive media guidance application performs an interactive media guidance application operation on the selected program. For example, the interactive media guidance application may receive a user instruction to perform an interactive media guidance application operation on the selected program. As another example, the interactive media guidance application may automatically perform a default interactive media guidance application operation on the selected program. The interactive media guidance application operation performed may include, for example, viewing the program (e.g., tuning to or streaming the program), purchasing the program, recording the program, setting a reminder for the program, or any other suitable operation. In some embodiments, the interactive media guidance application operation may be performed on the selected listing instead of or in addition to the selected program. Such interactive media guidance application operations may include, for example, deleting, moving, renaming, or setting a priority for the listing, placing the listing in a folder or group, adding a new listing, or any other suitable interactive media guidance application operation. Process 800 then end at step 814.

One skilled in the art will appreciate that the invention can be practiced by other than the prescribed embodiments, which are presented for purposes of illustration and not of limitation, and the invention is limited only by the claims which follow.

What is claimed is:

1. A method for saving information for media using an interactive media guidance application, comprising:
receiving a selection of media;
displaying information associated with the selected media;
receiving an instruction to save the displayed information; and
saving the displayed information.

2. The method of claim 1, wherein saving the displayed information further comprises saving the displayed information without saving the selected media.

3. The method of claim 1, further comprising:
receiving an instruction to retrieve the saved information; and
retrieving the saved information.

4. The method of claim 1, further comprising:
identifying a future transmission of the media associated with the saved information; and
receiving an instruction to access the identified future transmission of the media.

5. The method of claim 4, wherein receiving an instruction to access the identified future transmission further comprises at least one of recording the future transmission, setting a reminder for the future transmission, automatically tuning to the future transmission, downloading the future transmission, and purchasing access to the future transmission.

6. The method of claim 4, wherein:
receiving an instruction to save the displayed information further comprises receiving an instruction to save the displayed information from a first device; and
receiving an instruction to access the identified future transmission further comprises receiving an instruction to access the identified future transmission from a second device.

7. The method of claim 1, wherein saving the displayed information further comprises saving the displayed information in a location accessible from a plurality of devices accessible by the interactive media guidance application.

8. The method of claim 7, wherein saving the displayed information further comprises saving the displayed information in a location accessible over the Internet.

9. The method of claim 1, wherein saving the displayed information further comprises setting a flag directing the source of the displayed information not to delete the information.

10. The method of claim 1, wherein saving the displayed information further comprises associating the saved information with the user providing the instruction to save the displayed information.

11. The method of claim 1, wherein the information comprises at least one of a description of the selected media, actors, an image, and a video clip.

12. The method of claim 1, wherein the interactive media guidance application is implemented in a television system.

13. A system for saving information for media using an interactive media guidance application, the system comprising control circuitry and a display, the control circuitry operative to:
receive a selection of media;
direct the display to display information associated with the selected media;
receive an instruction to save the displayed information; and
save the displayed information.

14. The system of claim 13, wherein the control circuitry is further operative to save the displayed information without saving the selected media.

15. The system of claim 13, the control circuitry is further operative to:
receive an instruction to retrieve the saved information; and
retrieve the saved information.

16. The system of claim 13, the control circuitry is further operative to:
identify a future transmission of the media associated with the saved information; and
receive an instruction to access the identified future transmission of the media.

17. The system of claim 16, wherein the control circuitry is further operative to at least one of record the future transmission, set a reminder for the future transmission, automatically tune to the future transmission, download the future transmission, and purchase access to the future transmission.

18. The system of claim 16, wherein the control circuitry is further operative to:
receive an instruction to save the displayed information from a first device; and
receive an instruction to access the identified future transmission from a second device.

19. The system of claim 13, wherein the control circuitry is further operative to save the displayed information in a location accessible from a plurality of devices accessible by the interactive media guidance application.

20. The system of claim 19, wherein the control circuitry is further operative to save the displayed information in a location accessible over the Internet.

21. The system of claim 13, wherein the control circuitry is further operative to set a flag directing the source of the displayed information not to delete the information.

22. The system of claim 13, wherein the control circuitry is further operative to associate the saved information with the user providing the instruction to save the displayed information.

23. The system of claim 13, wherein the information comprises at least one of a description of the selected media, actors, an image, and a video clip.

24. The system of claim 13, wherein the interactive media guidance application is implemented in a television system.

25. A system for saving information for media using an interactive media guidance application, comprising:
means for receiving a selection of media;
means for displaying information associated with the selected media;
means for receiving an instruction to save the displayed information; and
means for saving the displayed information.

26. The system of claim 25, wherein means for saving the displayed information further comprises means for saving the displayed information without saving the selected media.

27. The system of claim 25, further comprising:
means for receiving an instruction to retrieve the saved information; and
means for retrieving the saved information.

28. The system of claim 25, further comprising:
means for identifying a future transmission of the media associated with the saved information; and
means for receiving an instruction to access the identified future transmission of the media.

29. The system of claim 28, wherein means for receiving an instruction to access the identified future transmission further comprises at least one of means for recording the future transmission, means for setting a reminder for the future transmission, means for automatically tuning to the future transmission, means for downloading the future transmission, and means for purchasing access to the future transmission.

30. The system of claim 28, wherein:
means for receiving an instruction to save the displayed information further comprises means for receiving an instruction to save the displayed information from a first device; and
means for receiving an instruction to access the identified future transmission further comprises means for receiving an instruction to access the identified future transmission from a second device.

31. The system of claim 25, wherein means for saving the displayed information further comprises means for saving the displayed information in a location accessible from a plurality of devices accessible by the interactive media guidance application.

32. The system of claim 31, wherein means for saving the displayed information further comprises means for saving the displayed information in a location accessible over the Internet.

33. The system of claim 25, wherein means for saving the displayed information further comprises means for setting a flag directing the source of the displayed information not to delete the information.

34. The system of claim 25, wherein means for saving the displayed information further comprises means for associating the saved information with the user providing the instruction to save the displayed information.

35. The system of claim 25, wherein the information comprises at least one of a description of the selected media, actors, an image, and a video clip.

36. The system of claim 25, wherein the interactive media guidance application is implemented in a television system.
